(19) United States
(12) Patent Application Publication
(10) Pub. No.: US 2005/0002094 A1
(43) Pub. Date: Jan. 6, 2005

(54) Substrate with concave portions, a microlens substrate, a transmission screen and a rear projection

(76) Inventors: Hideto Yamashita, Suwa-shi (JP); Masafumi Sakaguchi, Suwa-shi (JP); Nobuo Shimizu, Suwa-shi (JP)

Correspondence Address: HARNESS, DICKEY & PIERCE, P.L.C., P.O. BOX 828, BLOOMFIELD HILLS, MI, 48303, US

(21) Appl. No.: 10/823,383

(22) Filed: Apr. 12, 2004

(30) Foreign Application Priority Data
Apr. 15, 2003 (JP) 2003-110448

(51) Int. Cl. G03B 21/60

(52) U.S. Cl. 359/456

(57) ABSTRACT

A substrate with a plurality of concave portions according to the invention includes a substrate having. a plurality of concave portions. The concave portions are formed on the substrate by means of an etching process so that the plurality of concave portions are randomly arranged on the substrate. First, a non-polymerized resin is applied to the face on which the concave portions of the substrate with concave portions for microlenses are formed. By polymerizing and hardening (solidifying) this resin and further removing the substrate with concave portions for microlenses from a resin layer, the resin layer is formed on the substrate. Thus, microlenses that are constituted from the resin filled in the concave portions and function as convex lenses are formed in the resin layer.

### RELATED APPLICATION

The entire disclosure of Japanese Patent Application No. 2003-110448 filed Apr. 15, 2003 is incorporated by reference in its entirety.

### FIELD OF THE INVENTION

The present invention relates to a substrate with concave portions, a microlens substrate, a transmission screen, and a rear projection.

### BACKGROUND OF THE INVENTION

In recent years, demand for a rear projection is becoming increasingly strong as a suitable display for a monitor for a home theater, a large screen television, or the like.

In a transmission screen used for the rear projection, a lenticular lens is in general use. However, this type of screen has a problem that the vertical view angle thereof is small although the lateral view angle thereof is large (namely, there is a bias in the view angle).

As a solution to such a problem, there has been proposed a transmission screen (a screen for rear projection-type image display device) which uses a microlens array sheet (microlens substrate) in place of the lenticular lens. However, in such a conventional transmission screen provided with a microlens array having a periodic pattern, there is a problem that moire tends to take place in comparison with a case of using lenticular lenses because light passing through microlenses interferes.

### SUMMARY OF THE INVENTION

It is one object of the present invention to provide a microlens substrate, a transmission screen and a rear projection that can prevent occurrence of moire due to light interference effectively. Further, it is another object of the present invention to provide a substrate with concave portions capable of suitably using manufacture of the microlens substrate.

In order to achieve the above objects, in one aspect of the present invention, the present invention is directed to a substrate with concave portions. The substrate comprises a plurality of concave portions being formed on the substrate by means of an etching process so that the plurality of concave portions are randomly arranged on the substrate.

This makes it possible to provide a substrate with concave portions that can be suitably utilized for manufacturing a microlens substrate capable of preventing occurrence of moire effectively.

In the substrate of the present invention, it is preferable that the substrate is constituted from soda-lime glass.

This makes it possible to enhance ease of machining of the substrate (i.e., workability), whereby in particular, it is possible to make productivity of the substrate with concave portions better.

In the substrate of the present invention, it is preferable that the substrate has a usable area in which all the concave portions are formed wherein a ratio of an area occupied by all the concave portions in the usable area to the entire usable area is 90% or more when viewed from a top of the substrate.

This makes it possible to provide a substrate with concave portions that can be suitably utilized for manufacturing a microlens substrate capable of preventing harmful effects due to light not transmitting the microlens effectively.

In the substrate of the present invention, it is preferable that the concave portions are used for manufacturing microlenses.

This makes it possible to use for manufacturing a microlens substrate suitably.

In another aspect of the present invention, the present invention is directed to a microlens substrate comprising a plurality of microlenses. The plurality of microlenses are arranged on the substrate in an optically random order. The microlens substrate is manufactured using a substrate with a plurality of concave portions for providing the microlenses. The plurality of concave portions are formed on the substrate by means of an etching process so that the plurality of concave portions are randomly arranged on the substrate.

This makes it possible to provide a microlens substrate capable of preventing occurrence of moire effectively.

In yet another aspect of the present invention, the present invention is directed to a transmission screen comprising a microlens substrate with a plurality of microlenses. The plurality of microlenses are arranged on the substrate in an optically random order. The microlens substrate is manufactured using a substrate with a plurality of concave portions for providing the microlenses. The plurality of concave portions are formed on the substrate by means of an etching process so that the plurality of concave portions are randomly arranged on the substrate.

This makes it possible to provide a transmission screen capable of preventing occurrence of moire effectively.

It is preferable that the transmission screen of the present invention further comprises a Fresnel lens portion with a Fresnel lens, the Fresnel lens portion having an emission face and the Fresnel lens being formed in the emission face wherein the microlens substrate is arranged on the emission face side of the Fresnel lens portion.

This makes it possible to make a proper viewing angle range adjacent to a screen.

In the transmission screen of the present invention, it is preferable that the diameter of each of the microlenses is in the range of 10 to 500 μm.

This makes it possible to further enhance the productivity of the transmission screen while maintaining sufficient resolution in the image projected on the screen.

In still another aspect of the present invention, the present invention is directed to a rear projection comprising a transmission screen. The transmission screen has a microlens substrate with a plurality of microlenses. The plurality of microlenses are arranged on the substrate in an optically random order. The microlens substrate is manufactured using a substrate with a plurality of concave portions for providing the microlenses. The plurality of concave portions are formed on the substrate by means of an etching process so that the plurality of concave portions are randomly arranged on the substrate.

This makes it possible to provide a rear projection capable of preventing occurrence of moire effectively.

It is preferable that the rear projection according to the invention further comprises:
a projection optical unit; and
a light guiding mirror.

This makes it possible to provide a rear projection capable of preventing occurrence of moire effectively.

### BRIEF DESCRIPTION OF THE DRAWINGS

The foregoing and other objects, features and advantages of the invention will become more readily apparent from the following detailed description of preferred embodiments of the invention which proceeds with reference to the accompanying drawings.

FIG. 1 is a schematic longitudinal cross-sectional view showing a substrate with concave portions for microlenses of the present invention.

FIG. 2 is a schematic longitudinal cross-sectional view showing a microlens substrate of the present invention.

FIG. 3 is a schematic plan view showing a substrate with concave portions for microlenses of the present invention.

FIG. 4 is a schematic longitudinal cross-sectional view showing a method of manufacturing the substrate with concave portions for microlenses of the present invention.

FIG. 5 is a schematic longitudinal cross-sectional view showing a method of manufacturing the substrate with concave portions for microlenses of the present invention.

FIG. 6 is a schematic longitudinal cross-sectional view showing a method of manufacturing the substrate with concave portions for microlenses of the present invention.

FIG. 7 is a schematic longitudinal cross-sectional view showing a method of manufacturing the substrate with concave portions for microlenses of the present invention.

FIG. 8 is a schematic longitudinal cross-sectional view showing a method of manufacturing the substrate with concave portions for microlenses of the present invention.

FIG. 9 is a schematic longitudinal cross-sectional view showing a method of manufacturing the substrate with concave portions for microlenses of the present invention.

FIG. 10 is a schematic longitudinal cross-sectional view showing a method of manufacturing a microlens substrate of the present invention.

FIG. 11 is a schematic longitudinal cross-sectional view showing a method of manufacturing the microlens substrate of the present invention.

FIG. 12 is a schematic longitudinal cross-sectional view showing a method of manufacturing the microlens substrate of the present invention.

FIG. 13 is a schematic longitudinal cross-sectional view showing a method of manufacturing the substrate with concave portions for microlenses of the present invention.

FIG. 14 is a schematic longitudinal cross-sectional view showing a method of manufacturing the substrate with concave portions for microlenses of the present invention.

FIG. 15 is a schematic longitudinal cross-sectional view showing a method of manufacturing the substrate with concave portions for microlenses of the present invention.

FIG. 16 is a cross-sectional view schematically showing an optical system of a transmission screen of the present invention.

FIG. 17 is an exploded perspective view of the transmission screen shown in FIG. 16.

FIG. 18 is a diagram schematically showing a structure of a rear projection of this invention.

### PREFERRED EMBODIMENTS OF THE INVENTION

A detailed description of the preferred embodiments according to the present invention will now be made with reference to the accompanying drawings.

It is to be understood that each of a substrate with concave portions (a substrate with concave portions for microlenses) and a microlens substrate according to the invention includes both a separate substrate and a wafer.

Moreover, in the following description, the case of applying the substrate with concave portions of the invention to the substrate with concave portions for microlenses will be described as a representative example.

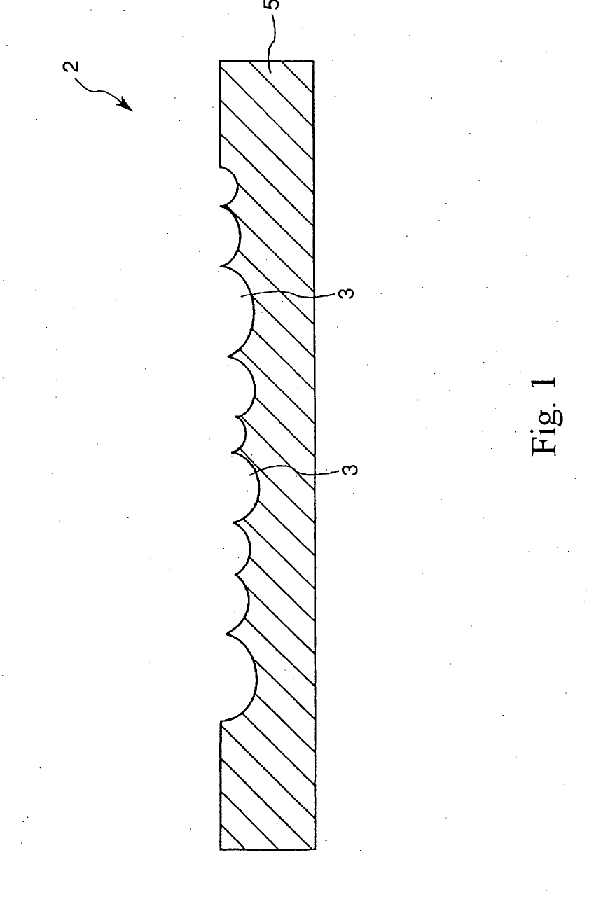

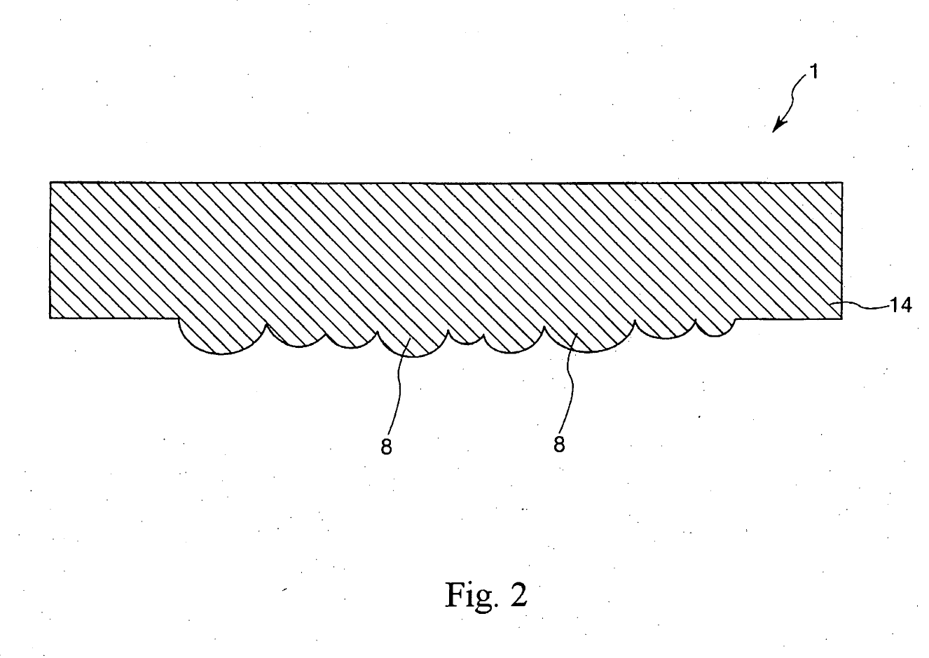

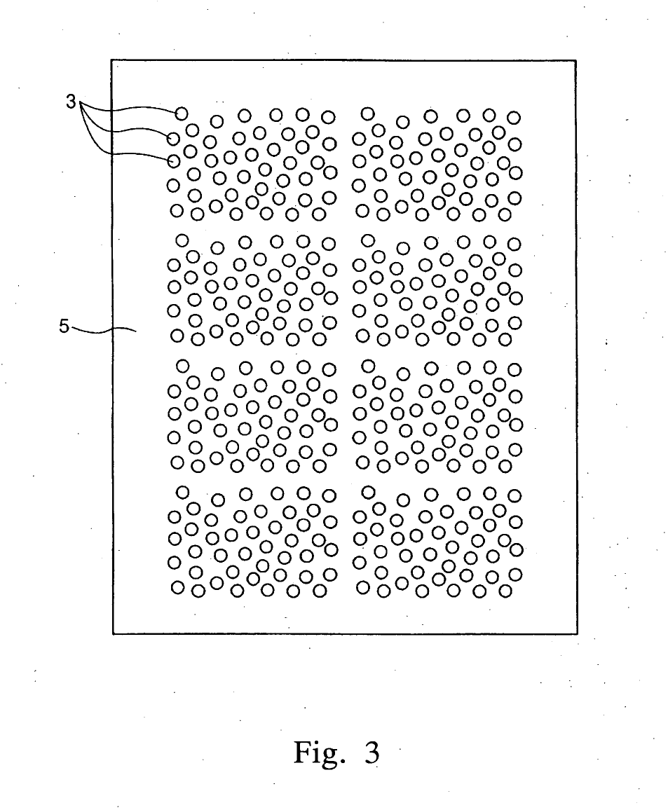

FIG. 1 is a schematic longitudinal cross-sectional view showing a substrate with concave portions for microlenses of the present invention. FIG. 2 is a schematic longitudinal cross-sectional view showing a microlens substrate of the present invention. FIG. 3 is a schematic longitudinal cross-sectional view showing a substrate with concave portions for microlenses of the present invention.

As shown in FIG. 1, a substrate 2 with concave portions for microlenses has a plurality of concave portions (for microlenses) 3 randomly arranged on a substrate 5.

By using such a substrate 2 with concave portions for microlenses, it is possible to obtain a microlens substrate 1 on which a plurality of microlenses 8 are arranged in an optically random order as shown in FIG. 2 (and FIG. 12 described later).

A term “in an optically random order” in the specification means that a plurality of microlenses 8 are arranged irregularly or at random so that it is possible to prevent and suppress occurrence of optical interference sufficiently.

As shown in FIG. 2, the microlens substrate 1 has a resin layer 14 on which microlenses 8 corresponding to the concave portions 3 of the substrate 2 with concave portions for microlenses are formed. The resin layer 14 is mainly constituted from resin material that is transparent with a predetermined index of refraction.

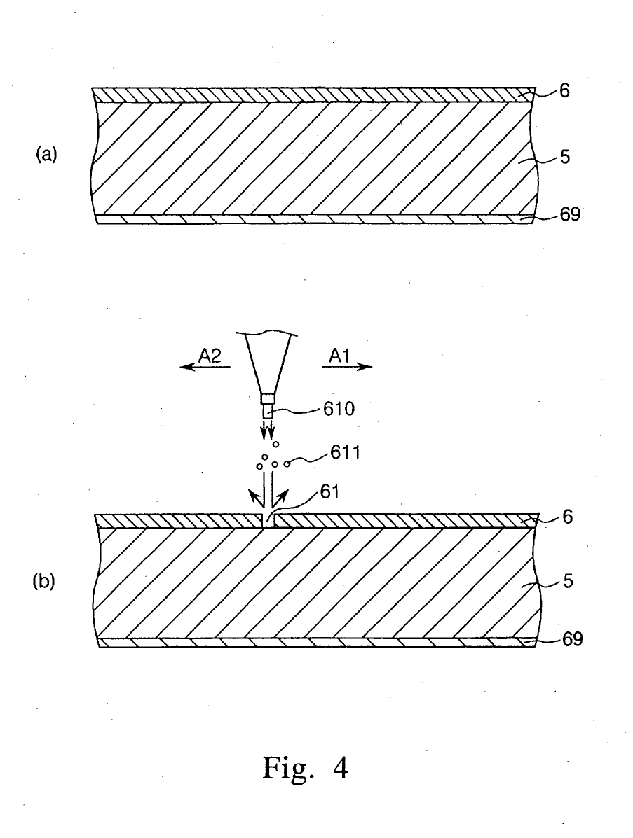

The substrate with concave portions for microlenses and the method of manufacturing the substrate with concave portions for microlenses of the invention will be described first with reference to FIGS. 4-9. In this regard, although a large number of concave portions for microlenses are actually formed on the substrate, the description in the following will be given by showing only a part of them in order to simplify the explanation thereof.

First, the substrate 5 is prepared in manufacturing the substrate 2 with concave portions for microlenses.

It is preferred that a substrate having a uniform thickness without flexure and blemishes is used for the substrate 5. Further, it is also preferred that a substrate with a surface cleaned by washing or the like is used for the substrate 5.

Although soda-lime glass, crystalline glass, quartz glass, lead glass, potassium glass, borosilicate glass, or the like may be mentioned as the material for the substrate 5, soda-lime glass and crystalline glass (for example, neoceram or the like) are preferable among them. By the use of soda-lime glass or crystalline glass, it is easy to process the material for the substrate 5, and it is advantageous from the viewpoint of manufacturing cost because soda-lime glass or crystalline glass is relatively inexpensive.

<1> As shown in FIG. 4(a), a mask 6 is formed on the surface of the prepared substrate 5 (mask formation process). Then, a rear face protective film 69 is formed on the rear face of the substrate 5 (i.e., the face side opposite to the face on which the mask 6 is formed). Needless to say, the mask 6 and the rear face protective film 69 may be formed simultaneously.

It is preferable that the mask 6 permits initial holes 61 to be formed therein by means of a physical method or irradiation with laser beams in step <2> (described later), and has resistance to etching in step <3> (described later). In other words, it is preferable that the mask 6 is constituted such that it has an etching rate nearly equal to or smaller than that of the substrate 5.

From such a viewpoint, for example, metals such as Cr, Au, Ni, Ti, Pt, and the like, alloys containing two or more kinds selected from these metals, oxides of these metals (metal oxides), silicon, resins, or the like may be mentioned as the material for the mask 6. Alternatively, the mask 6 may be given a laminated structure by a plurality of layers formed of different materials such as a Cr/Au laminate.

The method of forming the mask 6 is not particularly limited. In the case where the mask 6 is constituted from metal materials (including alloy) such as Cr and Au or metal oxides such as chromium oxide, the mask 6 can be suitably formed by evaporation method, sputtering method, or the like, for example. On the other hand, in the case where the mask 6 is formed of silicon, the mask 6 can be suitably formed by sputtering method, CVD method, or the like, for example.

In the case where the mask 6 is formed of chromium oxide or chromium as a main component thereof, the initial holes 61 can be easily formed by an initial hole formation process (described later), and the substrate 5 can be protected in the etching process more surely. Further, when the mask 6 has been formed of chromium oxide or chromium as a main component thereof, in the initial hole formation process (described later), a solution of ammonium fluoride (NH₄F), for example, may be used as an etchant. Since a solution containing ammonium fluoride is not poison, it is possible to prevent its influence on the human body during work and on the environment more surely.

In the case where the mask 6 is formed of Au as a main component thereof, by making the thickness of the mask 6 relatively large, for example, the impact of collision of blast media (shot balls) 611 during the blast processing in step <2> (described later) can be reduced, thereby being capable of making the shapes of the formed initial holes 61 well-balanced.

Although the thickness of the mask 6 also varies depending upon the material constituting the mask 6, it is preferable to be in the range of 0.05 to 2.0 μm, and more preferably it is in the range of 0.1 to 0.5 μm. If the thickness is below the lower limit given above, it becomes difficult depending upon the constituent material or the like of the mask 6 to sufficiently reduce the impact of the shot during the shot blast process in step <2> (described later), whereby there is a possibility to deform shapes of the formed initial holes 61. In addition, there is a possibility that sufficient protection for the masked portion of the substrate 5 cannot be obtained during a wet etching process in step <3> (described later). On the other hand, if the thickness is over the upper limit given above, in addition to the difficulty in formation of the initial holes 61 by means of the physical method or the irradiation with laser beams in step <2> (described later), there will be a case in which the mask 6 tends to be easily removed due to internal stress of the mask 6 depending upon the constituent material or the like of the mask 6.

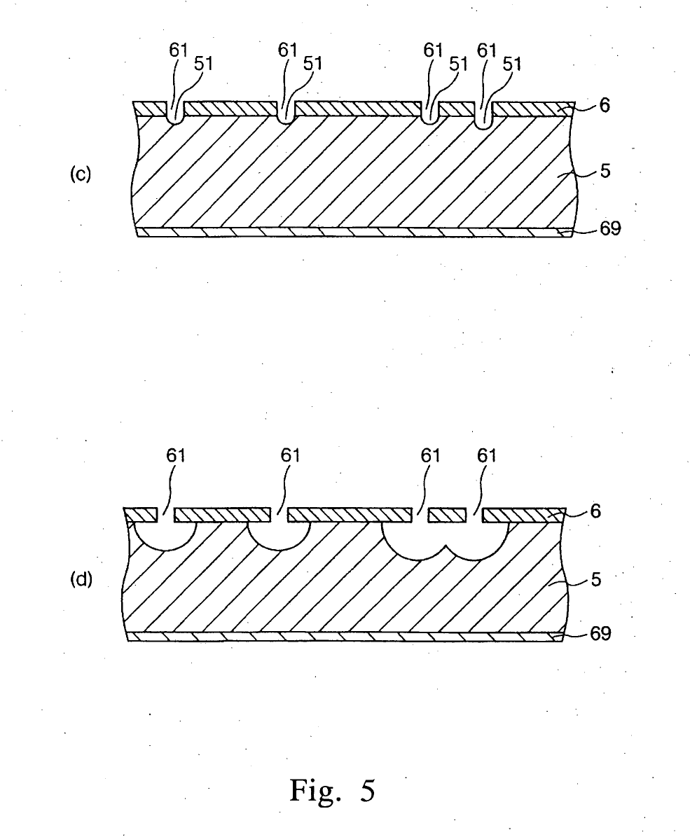

The rear face protective film 69 is provided for protecting the rear face of the substrate 5 in the subsequent processes. Erosion, deterioration or the like of the rear face of the substrate 5 is suitably prevented by means of the rear face protective film 69. Since the rear face protective film 69 is formed using the same material as the mask 6, it may be provided in a manner similar to the formation of the mask 6 simultaneous with the formation of the mask 6.

<2> Next, as shown in FIGS. 4(b) and 5(c), the plurality of initial holes 61 that will be utilized as mask openings in the etching (described later) are formed in the mask 6 at random by means of the physical method or the irradiation with laser beams (initial hole formation process).

The initial holes 61 may be formed in any method, but it is preferable that the initial holes 61 are formed by the physical method or the irradiation with laser beams. This makes it possible to manufacture the substrate with concave portions for microlenses at high productivity. In particular, the concave portions can be easily formed on a relatively large-sized substrate with concave portions for microlenses.

The physical methods of forming the initial holes 61 includes such methods as, for example, a blast processing such as shot blast, sand blast or the like, etching, pressing, dot printing, tapping, rubbing, or the like. In the case where the initial holes 61 are formed by means of the blast processing, it is possible to form the initial holes 61 with high efficiency in a shorter time even for a substrate 5 with a relatively large area (i.e., area of the region for formation of microlenses 8).

Further, in the case where the initial holes 61 are formed by means of irradiation with laser beams, the kind of laser beams to be used is not particularly limited, but a ruby laser, a semiconductor laser, a YAG laser, a femtosecond laser, a glass laser, a YVO₄ laser, a Ne-He laser, an Ar laser, a carbon dioxide laser, or the like may be mentioned. In the case where the initial holes 61 are formed by means of the irradiation of laser beams, it is possible to easily and precisely control the size of the initial holes 61, distance between adjacent initial holes 61, or the like.

Here, the case of forming the initial holes 61 on the mask 6 by employing shot blast as the physical method will be described as an example.

In the shot blast, as shown in FIG. 4(b), the initial holes 61 are formed in the mask 6 by spraying blast media 611 onto the surface of the mask 6 from a nozzle 610 arranged perpendicularly to the surface above the surface where the mask 6 is formed on the substrate 5. The initial holes 61 are formed on the entire surface of the mask 6 by applying shot blast over the entire surface of the mask 6 with the movement of the nozzle 610 in the direction as shown by arrows A1 and A2 in FIG. 4(b).

As the blast media 611, steel grit, brown fused alumina, white fused alumina, glass bead, stainless steel bead, garnet, silica sand, plastic, cut wire, slag, or the like may be mentioned, and glass bead is especially preferable among them. By using such blast media, it is possible to form the initial holes 61 on the mask 6 suitably.

It is preferable that the average diameter of the blast media 611 is in the range of 20 to 200 μm, and more preferably it is in the range of 50 to 100 μm. If the average diameter of the blast media 611 is less than the lower limit given above, the formation of the initial holes 61 with high efficiency may become difficult, or the particles of the blast media 611 may form an agglutination having a diameter over the upper limit given above by means of adsorption thereof. On the other hand, if the average diameter of the blast media 611 is over the upper limit given above, the formed initial holes 61 become large, the initial holes 61 become large-sized by mutual sticking, or initial holes 61 each having a different shape tend to be formed.

It is preferable that the blast pressure of the blast media 611 (i.e., this means air pressure in the spraying process) is in the range of 0.1 to 10 kg/cm², and more preferably it is in the range of 3 to 5 kg/cm². If the blast pressure of the blast media 611 is less than the lower limit given above, the impact of shot is weakened, whereby there is a case in which sure formation of the initial holes 61 in the mask 6 becomes difficult. On the other hand, if the blast pressure of the blast media 611 is over the upper limit given above, the impact of shot becomes too strong, and therefore, there is a possibility that the particles of blast media 611 are crushed, or the shape of the initial holes 61 is deformed by the impact.

Further, it is preferable that the spraying density (blast density; this means weight of the blast media 611 sprayed on per unit area of the mask 6) of the blast media 611 is in the range of 10 to 100 kg/m², and more preferably it is in the range of 30 to 50 kg/m². If the spraying density of the blast media 611 is less than the lower limit given above, the number of shots is decreased, and therefore, it takes a long time to form the initial holes 61 uniformly on the entire surface of the mask 6. On the other hand, if the spraying density of the blast media 611 is over the upper limit given above, the initial holes 61 are formed in an overlapping manner so that large holes are formed by joining with each other, or so that initial holes each having a different shape tend to be formed.

The initial holes 61 are formed in the mask 6 as shown in FIG. 5(c) by carrying out the shot blast mentioned above.

It is preferable that the initial holes are formed uniformly on the entire surface of the mask 6. Further, it is preferable that the initial holes 61 are formed in such a manner in which small holes are arranged with a predetermined interval so that there is no flat portion on the surface of the substrate 5, and that the surface is covered with concave portions with almost no space when a wet etching process is carried out in step <3> (described later). For that purpose, for example, the duration of the shot blast may be increased, or the shot blast process may be repeated for several times.

More specifically, for example, it is preferable that the shape of the formed initial holes 61 when viewed from a top of the substrate 5 is nearly circular and each of the initial holes 61 has an average diameter of the range of 2 to 10 μm. Further, it is preferable that the initial holes 61 are formed on the mask 6 at the rate of one thousand to one million holes per square centimeter (cm²), and more preferably ten thousand to 500 thousand holes per square centimeter (cm²). Furthermore, needless to say, the shape of the initial hole 61 is not limited to a nearly circular shape.

When the initial holes 61 are formed in the mask 6, as shown in FIG. 5(c), initial concave portions 51 may also be formed by removing parts of the surface of the substrate 5 in addition to the initial holes 61. This makes it possible to increase contact area with the etchant when the etching process in step <3> (described later) is carried out, whereby erosion can be started suitably. Further, by adjusting the depth of the initial concave portions 51 it is also possible to adjust the depth of the concave portions 3 (i.e., maximum thickness of the lens). Although the depth of the initial concave portion 51 is not particularly limited, it is preferable that it is 5.0 μm or less, and more preferably it is in the range of 0.1 to 0.5 μm.

As mentioned above, the case of forming the initial holes 61 in the mask 6 by means of the shot blast is described as an example, but the method of forming the initial holes 61 in the mask 6 is not limited to the shot blast. For example, the initial holes 61 may be formed in the mask 6 by a variety of physical methods mentioned above (for example, a blast processing other than shot blast, etching, pressing, dot printing, tapping, rubbing, or the like), irradiation with laser beams, or the like.

When the initial holes 61 are formed by pressing (press working), the initial holes 61 can be formed, for example, by pressing a roller having protrusions with a predetermined pattern (random pattern) on the mask 6 and rolling the roller over the mask 6.

Further, the initial holes 61 may be formed in the formed mask 6 not only by means of the physical method or the irradiation with laser beams, but also by, for example, previously arranging foreign objects on the substrate 5 with a predetermined pattern when the mask 6 is formed on the substrate 5, and then forming the mask 6 on the substrate 5 with the foreign objects to form defects in the mask 6 by design so that the defects are utilized as the initial holes 61.

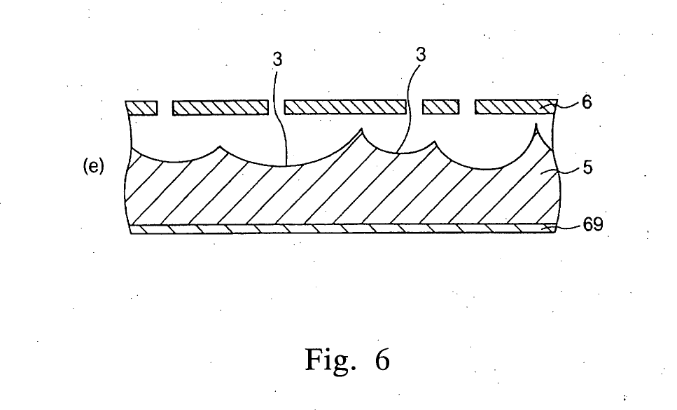

In this way, in the present invention, by the formation of the initial holes 61 in the mask by means of the physical method or the irradiation with laser beams, it is possible to randomly form openings (initial holes 61) in the mask easily and inexpensively compared with the formation of the openings in the mask 6 by means of the conventional photolithography method. Further, the physical method or the irradiation with laser beams makes it possible to deal with a large substrate easily.

<3> Next, as shown in FIGS. 5(d) and 6(e), a large number of concave portions 3 are randomly formed on the substrate 5 by applying the etching process to the substrate 5 using the mask 6 (etching process).

The etching method is not particularly limited, and a wet etching process, a dry etching process or the like may be mentioned as an example. In the following explanation, the case of using the wet etching process will be described as an example.

By applying the wet etching process to the substrate 5 covered with the mask 6 in which the initial holes 61 are formed, as shown in FIG. 5(d), the substrate 5 is eroded from the portions where no mask is present, namely, from the initial holes 61, whereby a large number of concave portions 3 are formed on the substrate 5. As mentioned above, since the initial holes 61 formed in the mask 6 are randomly provided, the formed concave portions 3 are randomly arranged on the surface of the substrate 5.

Further, in the present embodiment, the initial concave portions 51 are formed on the surface of the substrate 5 when the initial holes 61 are formed in the mask 6 in step <2>. This makes the contact area with the etchant increase during the etching process to the substrate, whereby the erosion can be made to start suitably.

Moreover, the formation of the concave portions 3 can be carried out suitably by employing the wet etching process. In the case where an etchant containing hydrofluoric acid (hydrofluoric acid-based etchant) is utilized for an etchant, for example, the substrate 5 can be eroded more selectively, and this makes it possible to form the concave portions 3 suitably.

In the case where the mask 6 is mainly constituted from chromium (i.e., the mask 6 is formed of a material containing Cr as a main component thereof), a solution of ammonium fluoride is particularly suited as a hydrofluoric acid-based etchant. Since a solution containing ammonium fluoride is not poison, it is possible to prevent its influence on the human body during work and on the environment more surely.

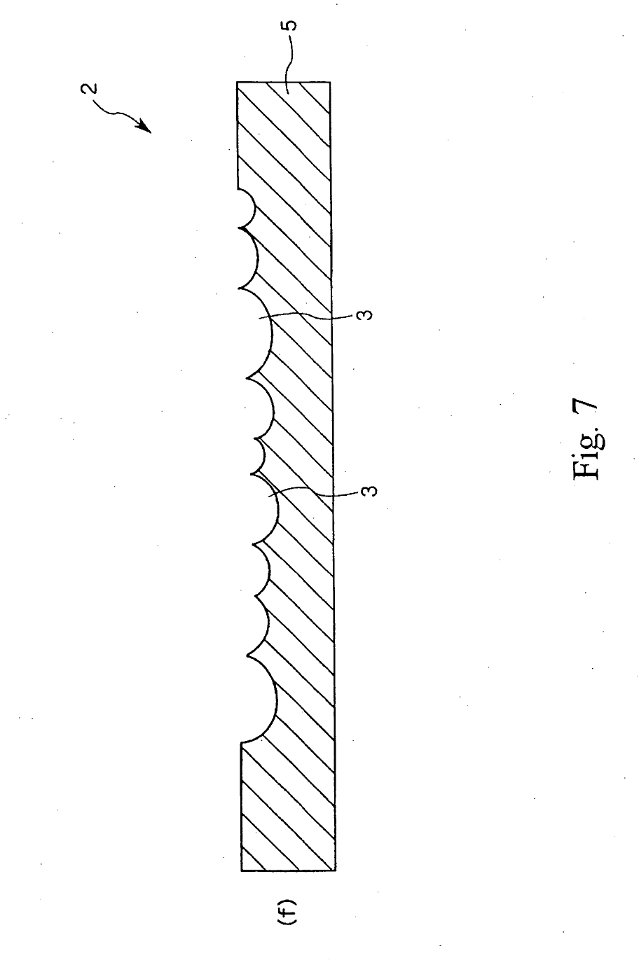

Further, the wet etching process permits the processing with simpler equipment than in the dry etching process, and allows the processing for a larger number of substrates at a time. This makes it possible to enhance productivity of the substrates, and it is possible to provide substrate 2 with concave portions for microlenses at a lower cost.

<4> Next, the mask 6 is removed as shown in FIG. 7(f) (mask removal process). At this time, the rear face protective film 69 is removed along with the removal of the mask 6.

In the case where the mask 6 is mainly constituted from chromium, the removal of the mask 6 can be carried out by means of an etching process using a mixture of ceric ammonium nitrate and perchloric acid, for example.

As a result of the processing in the above, as shown in FIGS. 7(f) and 3, a substrate 2 with concave portions for microlenses in which a large number of concave portions 3 are randomly formed on the substrate 5 is obtained.

It is preferable that the concave portions 3 are formed on the substrate 5 with relative denseness. More specifically, it is preferable that a ratio of an area occupied by all the concave portions 3 in a usable area to the entire usable area is 90% or more when viewed from a top of the substrate 5. Namely, the substrate 2 with concave portions for microlenses has the usual area in which all the concave portions 3 are formed. In the case where the ratio of the area occupied by all the concave portions 3 in a usable area to the entire usable area is 90% or more, it is possible to reduce straight light passing through an area other than the area where the concave portions 3 reside, thereby being capable of enhancing the usability of light further.

The method of randomly forming the concave portions 3 on the substrate 5 is not particular limited. In the case where the concave portions 3 are formed by means of the method mentioned above, namely, the method of forming the concave portions 3 on the substrate 5 by forming the initial holes 61 in the mask 6 by means of the physical method or the irradiation with laser beams and then carrying out an etching process using the mask 6, it is possible to obtain the following effects.

Namely, by forming the initial holes 61 in the mask 6 by means of a physical method or irradiation with laser beams, it is possible to form openings (initial holes 61) in a predetermined pattern in the mask 6 easily and inexpensively compared with the case of forming the openings in the mask 6 by means of the conventional photolithography method. This makes it possible to enhance productivity of the substrate 2 with concave portions for microlenses, whereby it is possible to provide the substrate 2 with concave portions for microlenses at a lower cost.

Further, according to the method described above, it is possible to carry out a processing for a large-sized substrate easily. Also, according to the method, in the case of manufacturing such a large-sized substrate, there is no need to bond a plurality of substrates as the conventional method, whereby it is possible to eliminate the appearance of seams of bonding. This makes it possible to manufacture a high quality large-sized substrate with concave portions for microlenses by means of a simple method at a low cost.

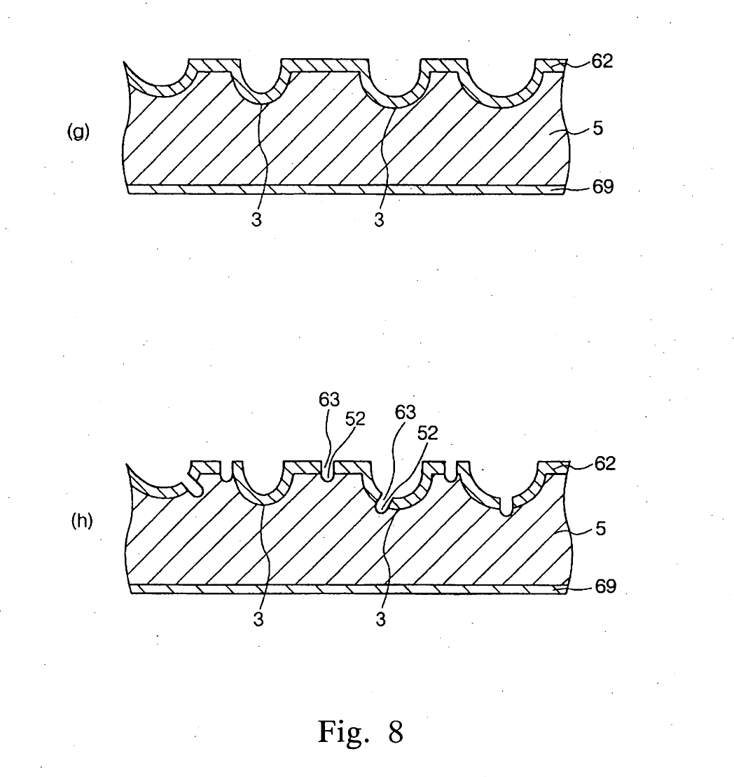

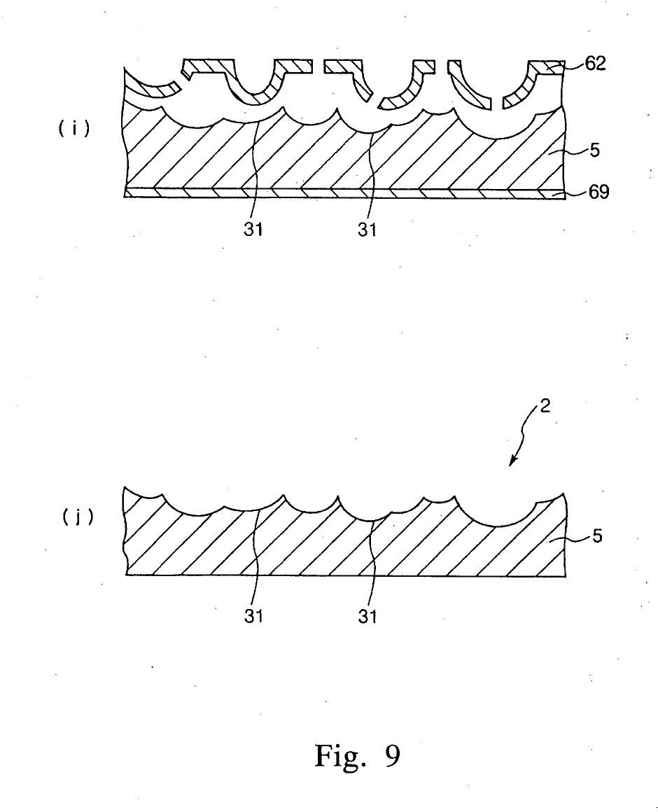

Moreover, after the mask 6 is removed in step <4>, a new mask 62 may be formed on the substrate 5, and then a series of processes including a mask formation process, an initial hole formation process, a wet etching process, and a mask removal process may be repeated. Hereinafter, a specific example will be described.

<B1> First, as shown in FIG. 8(g), a new mask 62 is formed on the substrate 5 on which the concave portions 3 are formed. The mask 62 may be formed in the same way as the mask 6 described above (mask formation process).

<B2> Next, as shown in FIG. 8(h), initial holes 63 are formed in the mask 62 by means of the physical method or the irradiation with laser beams described above (initial hole formation process). At this time, as shown in FIG. 8(h), initial concave portions 52 may be formed on the surface of the substrate 5.

<B3> Then, as shown in FIG. 9(i), concave portions 31 are formed by applying an etching process similar to the above-mentioned process using the mask 62 (etching process).

<B4> Finally, as shown in FIG. 90), the mask 62 and the rear face protective film 69 are removed (mask removal process).

Steps <B1> to <B4> may be carried out by the methods similar to steps <1> to <4>.

In this way, by repeatedly carrying out a series of processes, it is possible to form concave portions over the entire surface of the substrate 5 without bias, and to arrange the shape of the concave portions uniformly.

Further, the conditions in each process may be changed for the second or subsequent rounds from those of the first round. By changing the conditions in each process to adjust the shape (size, depth, curvature, concave shape of the concave portion, or the like) of the formed concave portions 3, the substrate 5 having a desired form may be obtained.

For example, in the initial hole formation process, the size and the density of the initial holes 61 formed in the mask 6, and the size and the depth of the initial concave portions 51 formed in the substrate 5, or the like, can be adjusted by changing the conditions such as the diameter of the blast media 611, the blast pressure or the spraying density of the blast media 611, the processing duration, or the like.

Further, in the etching process, the shape of the formed concave portions 3 can be adjusted by changing the etching rate. For example, by decreasing the etching rate gradually, it is possible to arrange the shape of a plurality of formed concave portions 3 uniformly.

Moreover, for example, in the first round of the etching process, by setting the etching rate to a large (or small) value, flat portions of the substrate surface may be eliminated (pre-etching process), and in the second and the subsequent rounds of the etching process, by setting the etching rate to a small (or large) value, the concave portions 3 may be formed (regular etching process).

Furthermore, by changing the size of the initial holes 61 the size and the depth of the initial concave portions 51, or the like, and further by changing the etching rate, it is possible to make the formed concave portions 3 become a desired aspherical shape.

Here, in the case where the series of processes described above are carried out repeatedly, the rear face protective film 69 may be used repeatedly without being removed in step <4> or the like.

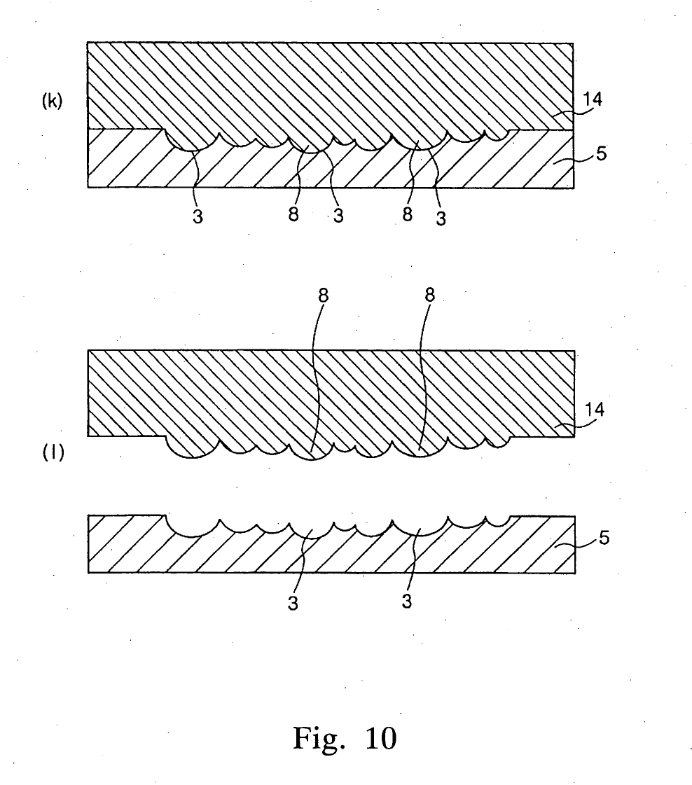

Hereinafter, a method of manufacturing a microlens substrate using the substrate 2 with concave portions for microlenses will be described with reference to FIG. 10.

In this regard, needless to say, the substrate 2 with concave portions for microlenses and the microlens substrate of the invention can be used for a transmission screen and a rear projection (described later), and in addition, they can be used for various kinds of electro-optical devices such as a liquid crystal display (liquid crystal panel), an organic or inorganic electroluminescent (EL) display, a charge-coupled device (CCD), an optical communication device or the like, and other devices.

<5> First, a non-polymerized resin is applied to the face on which the concave portions 3 of the substrate 2 with concave portions for microlenses are formed. By polymerizing and hardening (solidifying) this resin, as shown in FIG. 10(k), a resin layer 14 is formed on the substrate 5. Thus, microlenses 8 that are constituted from the resin filled in the concave portions 3 and function as convex lenses are formed in the resin layer 14.

<6> Next, as shown in FIG. 10(1), the substrate 2 with concave portions for microlenses that is a mold for the microlenses 8 is removed from the microlenses 8 (i.e., the resin layer 14).

In this way, as shown in FIG. 2, a microlens substrate 1 on which a large number of microlenses 8 are randomly arranged is obtained.

As mentioned above, these microlenses 8 are arranged on the microlens substrate 1 in an optically random order. Thus, it is possible to prevent and suppress occurrence of optical interference by the light transmitting (or passing) through the microlenses 8. Therefore, in the case where the microlens substrate of the present invention is utilized for a transmission screen described above, for example, it is possible to prevent occurrence of so-called moire almost completely. This makes it possible to obtain a fine transmission screen having a good quality of display.

As an indicator indicating a degree of randomness (irregularity) of the microlens 8 (or concave portion 3), for example, a standard deviation that is obtained using a large number of distances between arbitrarily adjacent two points (for example, between a microlens 8 and an adjacent microlens 8 or between a concave portion 3 and an adjacent concave portion 3) is mentioned. In the present invention, it is preferable that the obtained standard deviation indicates a degree of randomness (irregularity) of more than 3% to the average value of the large number of distances. When the indicator is in the range of values, it is possible to prevent occurrence of optical interference effectively.

In this regard, in the above description of the method of manufacturing the microlens substrate, the case where the microlens substrate 1 is constituted from only one resin layer 14 was described as an example. However, the microlens substrate that is constituted from a plurality of resin layers may also be manufactured by the 2P method (photopolymerization).

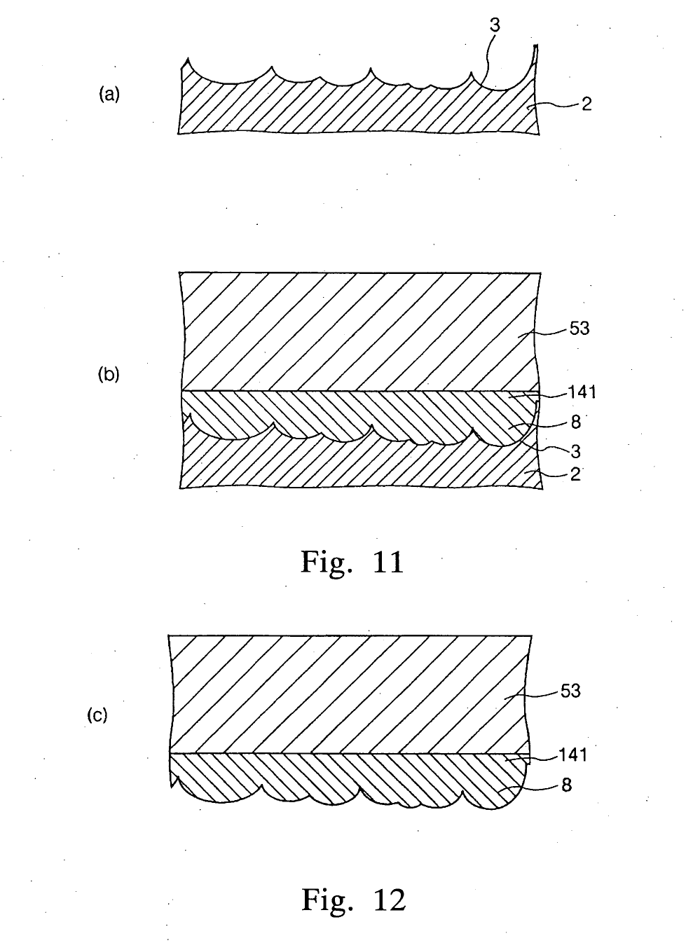

Hereinafter, a method of manufacturing the microlens substrate by means of the 2P method will be described with reference to FIGS. 11 and 12.

First, as shown in FIG. 11(a), the substrate 2 with concave portions for microlenses having a plurality of concave portions 3 for microlenses, which is manufactured using the present invention, is prepared. In this method, the substrate 2 with concave portions for microlenses having the plurality of concave portions 3 is utilized as a mold. By filling resin in the concave portions 3, the microlenses 8 are formed. In this case, the inner surface of the concave portions 3 may be coated with a mold release agent or the like, for example. Then, the substrate 2 with concave portions for microlenses is set, for example, so as to have the concave portions 3 open vertically upward.

<C1> Next, uncured resin that will constitute a resin layer 141 (microlenses 8) is supplied on the substrate 2 with concave portions for microlenses having the concave portions 3.

<C2> Next, a resin layer 53 is joined to the uncured resin, and the resin layer 53 is made to be closely contacted with the uncured resin by pressing.

<C3> Next, the resin is cured (or hardened). The method of curing the resin is appropriately selected according to the kind of the resin, and for example, ultraviolet irradiation, heating, electron beam irradiation, or the like may be mentioned.

In this way, as shown in FIG. 11(b), the resin layer 141 is formed, and the microlenses 8 are formed by means of the resin filled in the concave portions 3.

<C4> Next, as shown in FIG. 12(c), the substrate 2 with concave portions for microlenses functioning as the mold is removed from the microlenses 8.

Thus, it is possible to obtain a microlens substrate on which a plurality of microlenses 8 are arranged as shown in FIG. 12(c).

Further, in the above explanation, it is described that the substrate 2 with concave portions for microlenses is manufactured by the etching process using the mask 6. However, the substrate 2 with concave portions for microlenses of the present invention may be any one as long as a plurality of concave portions 3 are formed on the substrate 2 with concave portions for microlenses by the etching process. For example, it may be one manufactured by the etching process without a mask as described later. Hereinafter, an example of this method will be described.

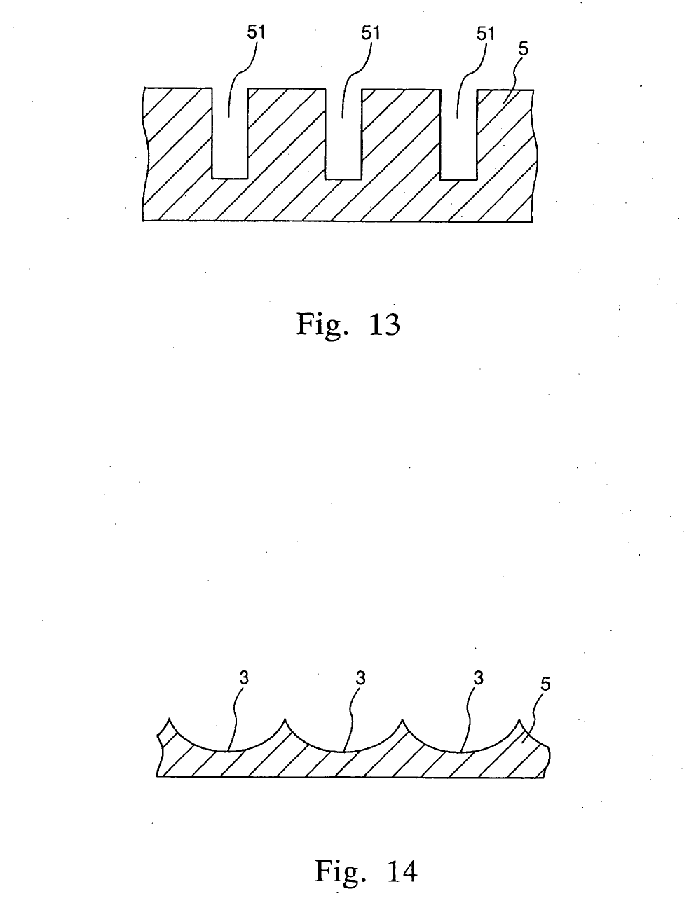

First, the substrate (base material) 5 is prepared in manufacturing the substrate 2 with concave portions for microlenses as well as the embodiment described above.

<D1> Next, as shown in FIG. 13, initial concave portions 51 are formed on the prepared substrate 5 (initial concave portion formation process).

In this way, in the present embodiment, the initial concave portions 51 are directly formed on the substrate 5 without forming a mask on the substrate 5. As the method of forming the initial concave portions 51, the same methods as the methods of forming the initial holes 61 described above can be used, for example. More specifically, the methods includes laser machining, a blast processing such as shot blast, sand blast or the like, etching, pressing, dot printing, tapping, or the like.

In the case where the initial concave portions 51 are formed by means of the laser machining, it is possible to form the initial concave portions 51 with a predetermined pattern effectively and precisely. Further, it is possible to easily control a diameter and a depth of each of the initial concave portions 51, an interval between the adjacent two initial concave portions 51, or the like. In the case where the initial concave portions 51 are formed by means of the laser machining (i.e., irradiation with laser beams), as laser beams to be used, for example, a ruby laser, a semiconductor laser, a YAG laser, a femtosecond laser, a glass laser, a YVO₄ laser, a Ne-He laser, an Ar laser, a carbon dioxide laser, or the like may be mentioned. Among these laser beams, the YAG laser or the femtosecond laser is preferably used because such a laser can be continuously oscillated at room temperature easily, and the controllability of such a laser provides better performance in a low irradiation-energy range. This makes it possible to form the initial concave portions 51 on the substrate 5 suitably.

Further, it is preferable that a beam diameter of the laser beam is in the range of 1.0 to 100 μm, and more preferably it is in the range of 2.0 to 20 μm. If the beam diameter of the laser beam is below the lower limit given above, the diameter of each of the formed initial concave portions 51 becomes too small, whereby there is a possibility that an etchant cannot reach a bottom of the initial concave portion 51 sufficiently when applying an etching process to the substrate 5 in an etching step described later. On the other hand, if the beam diameter of the laser beam is over the upper limit given above, the formed initial concave portions 51 become large, the initial concave portions 51 become large-sized by mutual sticking, or initial concave portions 51 each having a different shape tend to be formed.

In the case where the initial concave portions 51 are formed by means of the blast machining, it is possible to form the initial concave portions 51 on the substrate 5 in a short time and a wide range efficiently. For example, as the blast media (shot ball) used in the blast machining, steel grit, brown fused alumina, white fused alumina, glass bead, stainless steel bead, garnet, silica sand, plastic, cut wire, slag, or the like may be mentioned, and glass bead is especially preferable among them. By using such blast media, it is possible to form the initial concave portions 51 on the substrate 5 suitably.

It is preferable that the average diameter of the blast media is in the range of 10 to 200 μm, and more preferably it is in the range of 20 to 100 μm. If the average diameter of the blast media is less than the lower limit given above, the diameter of each of the formed initial concave portions 51 becomes too small, whereby there is a possibility that an etchant cannot reach a bottom of the initial concave portion 51 sufficiently when applying an etching process to the substrate 5 in an etching step described later. On the other hand, if the average diameter of the blast media is over the upper limit given above, the formed initial concave portions 51 become large, the initial concave portions 51 become large-sized by mutual sticking, or initial concave portions 51 each having a different shape tend to be formed.

Further, it is preferable that the blast pressure of the blast media (i.e., this means air pressure in the spraying process) is in the range of 1 to 10 kg/cm², and more preferably it is in the range of 3 to 5 kg/cm². If the blast pressure of the blast media is less than the lower limit given above, the impact of shot is weakened, whereby there is a case in which sure formation of the initial concave portion 51 in the substrate 5 becomes difficult. On the other hand, if the blast pressure of the blast media is over the upper limit given above, the impact of shot becomes too strong, and therefore, there is a possibility that the particles of blast media are crushed, or the shape of the initial concave portion 51 is deformed by the impact.

Moreover, it is preferable that the spraying density (blast density; this means weight of the blast media sprayed on per unit area of the substrate 5) of the blast media is in the range of 10 to 100 kg/m², and more preferably it is in the range of 30 to 50 kg/m². If the spraying density of the blast media is less than the lower limit given above, the number of shots is decreased, and therefore, it takes a long time to form the initial concave portions 51 uniformly on the entire surface of the substrate 5. On the other hand, if the spraying density of the blast media is over the upper limit given above, the initial concave portions 51 are formed in an overlapping manner so that large holes are formed by joining with each other, or so that initial concave portions each having a different shape tend to be formed.

Although a shape of the initial concave portion 51 when viewed from a top of the substrate 5 is not particularly limited, it is preferable that the shape is a substantially circular form. If the initial concave portion 51 has such a shape, it is possible to use for manufacturing a microlens substrate (described later) suitably.

In the following description, it is supposed that each of the initial concave portions 51 has a substantially circular shape.

Further, in the case where the diameter and the depth of the initial concave portion 51 are respectively a (μm) and b (μm), it is preferable to satisfy a relationship that a/b is less than 0.25 (i.e., a/b≦0.25), and more preferably to satisfy a relationship that a/b is less than 0.2 (i.e., a/b≦0.2). By satisfying such a relationship, it is possible to make the rate at which the substrate 5 is eroded appropriate in an etching step described later. Further, the shape of each of the formed concave portions 3 becomes optimum to obtain a microlens with superior optical characteristics particularly. On the contrary, if the ratio a/b is below the lower limit given above, there is a possibility that an etchant cannot reach a bottom of the initial concave portion 51 sufficiently when applying an etching process to the substrate 5 in an etching step described later, thereby obtaining effects of the present invention sufficiently. Further, there is a possibility that it becomes difficult to control the shape of the formed concave portion 3 surely because the rate at which the etchant comes in the initial concave portions 51 cannot be controlled. Further, if the ratio a/b is over the upper limit given above, it becomes difficult to make the curvature radius of the concave portion 3 formed in the etching step described above sufficiently small, whereby there is a possibility that it is difficult to obtain sufficient optical characteristics in the microlens substrate.

In the case where a diameter of the finally formed concave portion 3 is d (μm), it is preferable that a relationship between the diameter a of the initial concave portion 51 and the diameter d of the final concave portion 3 satisfies a relationship that a/d is less than 0.25 (i.e., a/d≦0.25), and more preferably the relationship satisfies a relationship that a/d is less than 0.2 (i.e., a/d≦0.2). By satisfying such a relationship, it is possible to manufacture a microlens substrate having an appropriate curvature radius when the microlens substrate (described later) is manufactured.

Although a concrete value of the diameter a of the initial concave portion 51 is not particularly limited, it is preferable that the diameter a is in the range of 1.0 to 50 μm, and more preferably it is in the range of 2.0 to 20 μm. If the diameter a of the initial concave portion 51 is below the lower limit given above, there is a possibility that an etchant cannot reach a bottom of the initial concave portion 51 sufficiently when applying an etching process to the substrate 5 in an etching step described later. On the other hand, if the diameter a of the initial concave portion 51 is over the upper limit given above, it becomes difficult to make the curvature radius of the concave portion 3 formed in the etching step described above sufficiently small, whereby there is a possibility that it is difficult to obtain sufficient optical characteristics in the microlens substrate.

Further, although a concrete value of the depth b of the initial concave portion 51 is not particularly limited, it is preferable that the depth b is in the range of 5 to 500 μm, and more preferably it is in the range of 10 to 200 μm. If the depth b of the initial concave portion 51 is below the lower limit given above, it becomes difficult to make the curvature radius of the concave portion 3 formed in the etching step described above sufficiently small, whereby there is a possibility that it is difficult to obtain sufficient optical characteristics in the microlens substrate. On the other hand, if the depth b of the initial concave portion 51 is over the upper limit given above, there is a possibility that an etchant cannot reach a bottom of the initial concave portion 51 sufficiently when applying an etching process to the substrate 5 in an etching step described later. In this regard, needless to say, the shape of the initial concave portion 51 is not limited to a substantially circle form.

Moreover, in the present embodiment, a plurality of initial concave portions 51 are formed on the substrate 5. In the case where the interval between two adjacent initial concave portions 51 is c (μm), it is preferable that a relationship between the interval c and the depth b of the initial concave portion 51 satisfies a relationship of 0.8≦c/b≦1.1, more preferably the relationship satisfies a relationship of 0.9≦c/b≦1.0. By satisfying such a relationship, it is possible to form the concave portions 3 each having an appropriate size on the substrate 5 densely. On the contrary, if the ratio c/b is below the lower limit given above, it becomes difficult to make the curvature radius of the concave portion 3 formed in the etching step described above sufficiently small, whereby there is a possibility that it is difficult to obtain sufficient optical characteristics in the microlens substrate. Further, if the ratio c/b is over the upper limit given above, there is a possibility that it becomes difficult to form sufficiently small microlenses on the substrate 5 densely.

Although a concrete value of the interval c between two adjacent initial concave portions 51 is not particularly limited, it is preferable that the interval c is in the range of 5 to 500 μm, and more preferably it is in the range of 10 to 200 μm. If the interval c is below the lower limit given above, there is a possibility that the formation of the initial concave portion 51 becomes difficult. Further, if the interval c is too small, there is a possibility that the problems mentioned above occur because the diameter of the initial concave portion 51 also becomes small. On the other hand, if the interval c is over the upper limit given above, there is a possibility that it becomes difficult to form sufficiently small microlenses on the substrate 5.

<D2> Next, as shown in FIG. 14, a large number of concave portions 3 are formed on the substrate 5 by applying the etching process to the substrate 5 on which a plurality of initial concave portions 51 were formed (etching process).

In this way, in the present embodiment, the large number of concave portions 3 are formed on the substrate 5 by applying the etching process to the substrate 5 on which the plurality of initial concave portions 51 were formed without forming a mask 6.

The etching method is not particularly limited, and a wet etching process or a dry etching process or the like may be mentioned. It is preferable to use the wet etching process among them. Thus, the wet etching process permits the processing with simpler equipment than in the dry etching process, and allows the processing for a larger number of substrates at a time. As a result, productivity of the substrates can be enhanced, and substrate 2 with concave portions for microlenses can be provided at a lower cost.

In the case where the wet etching method is used in the etching methods mentioned above, it is possible to use aqueous solution of hydrofluoric acid, aqueous solution of ammonium hydrogen difluoride, aqueous solution of hydrofluoric acid and nitric acid, aqueous solution of iron(III) chloride, aqueous solution of alkali, or the like as an etchant.

Further, in the case where the dry etching method is used, it is possible to use trifluoromethane gas, chlorine-based gas, or the like as an etchant.

In the following explanation, the case of using the wet etching process will be described as an example.

By applying the wet etching process to the substrate 5 on which the initial concave portions 51 are formed, as shown in FIG. 14, the substrate 5 is eroded from the initial concave portions 51, whereby a large number of concave portions 3 are formed on the substrate 5.

Further, the formation of the concave portions 3 can be carried out suitably by employing the wet etching process. In the case where an etchant containing hydrofluoric acid (hydrofluoric acid-based etchant) is utilized, for example, the substrate 5 is eroded more selectively, and this makes it possible to form the concave portions 3 suitably.

In this regard, new initial concave portions 51 may be further formed on the face of the substrate 5 on which the concave portions 3 were formed to repeatedly carry out a series of the initial concave portion formation step and the etching step. Namely, the steps <D1> and <D2> may be repeatedly carried out. This makes it possible to form the concave portions 3 over the entire surface of the substrate 5 without bias. Further, it is possible to arrange the shape of the concave portions 3 uniformly. In this case, the conditions in each process of the second or subsequent rounds may be the same as or different from those of the first round.

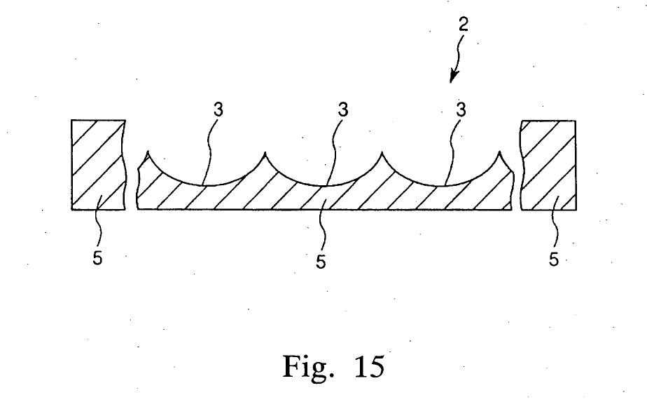

As a result of the processings in the above, as shown in FIG. 15, a substrate 2 with concave portions for microlenses having a large number of concave portions 3 on the substrate 5 is obtained.

In the above description, a microlens substrate provided with plano-convex lenses (piano-convex microlenses) on one face of which microlenses are formed is used, but the microlens substrate according to the present invention is not limited to this type.

For example, a microlens substrate provided with biconvex lenses on both faces of which microlenses are formed may be used.

Further, although in the above description a glass substrate is used as the substrate 2 with concave portions for microlenses, the constituent material of the substrate 5 is not limited to glass in the present invention. A metal or resin, for example, may be used for the substrate 5.

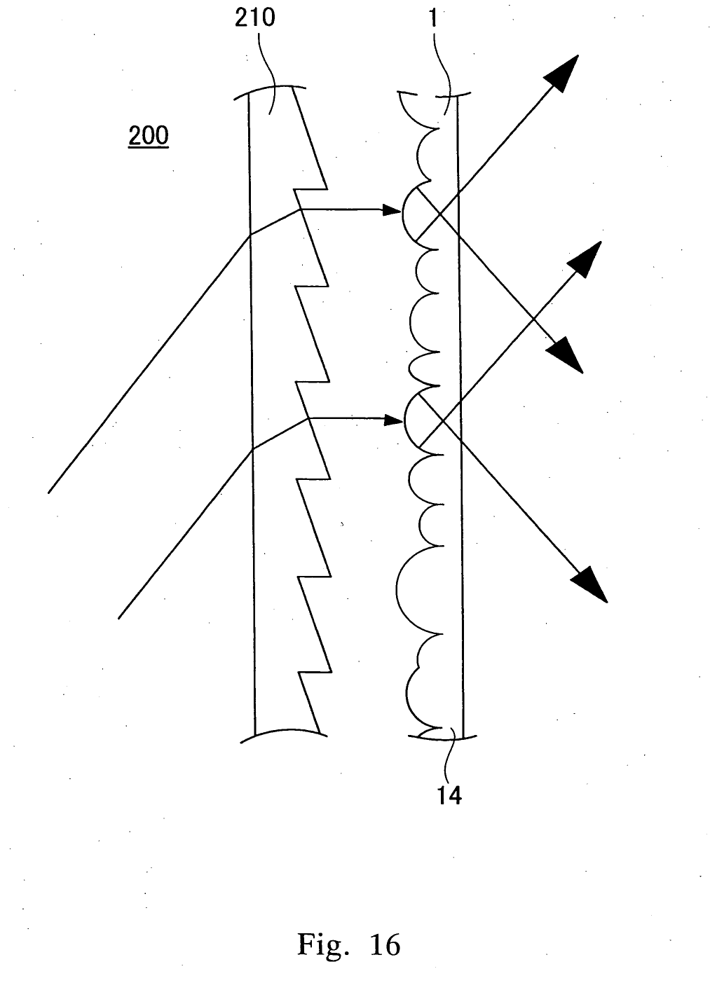

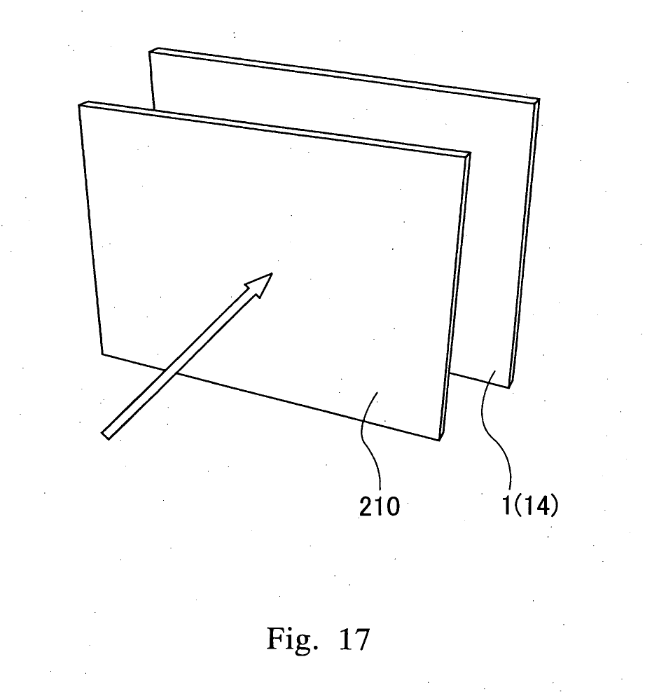

Next, a description will be given for a transmission screen using the microlens substrate 1 shown in FIG. 2 with reference to FIGS. 16 and 17. FIG. 16 is a cross-sectional view schematically showing the optical system of a transmission screen according to the present invention. FIG. 17 is an exploded perspective view of the transmission screen shown in FIG. 16.

A transmission screen 200 comprises a Fresnel lens portion 210 with a Fresnel lens formed on the surface for emission face thereof, and the microlens substrate 1 with a large number of microlenses 8 formed on the incident face side that is arranged on the emission face side of the Fresnel lens portion 210.

In this way, the transmission screen 200 has the microlens substrate 1, and therefore, the view angle in the vertical direction is wider than the case of using a lenticular lens.

In particular, as described above, since the microlenses 8 are randomly arranged in the microlens substrate 1 of the present invention, it is possible to prevent light valve of a liquid crystal display (LCD) or the like, or interference to the Fresnel lens. This makes it possible to prevent occurrence of moire almost completely. Thus, it is possible to obtain an excellent transmission screen with a high display quality.

Further, according to the method as mentioned above, it is possible to manufacture a large-sized microlens substrate 1 easily. This makes it possible to manufacture a large-sized screen with a high quality and free from the bonding seams.

It is preferable that the diameter of each of the microlenses 8 in the microlens substrate 1 is in the range of 10 to 500 μm, and more preferably it is in the range of 30 to 80 μm, and further more preferably it is in the range of 50 to 60 μm. By restricting the diameter of each of the microlenses 8 in the above ranges, it is possible to further enhance the productivity of the transmission screen while maintaining sufficient resolution in the image projected on the screen. In this regard, it is preferable that the pitch between adjacent microlenses 8 in the microlens substrate 1 is in the range of 10 to 500 μm, more preferably the pitch is in the range of 30 to 300 μm, and further more preferably the pitch is in the range of 50 to 200 μm.

Further, according to the method as mentioned above, it is possible to manufacture a large-sized microlens substrate 1 easily. Therefore, it is possible to manufacture a large-sized screen with a high quality and free from the bonding seams.

In this regard, the transmission screen of the present invention is not limited to the structure as described above. For example, a transmission screen further comprising black stripes, light diffusion plate or another microlens on the emission face side or the incident face side of the microlens substrate 1 may be provided.

Hereinafter, a description will be given for a rear projection using the transmission screen.

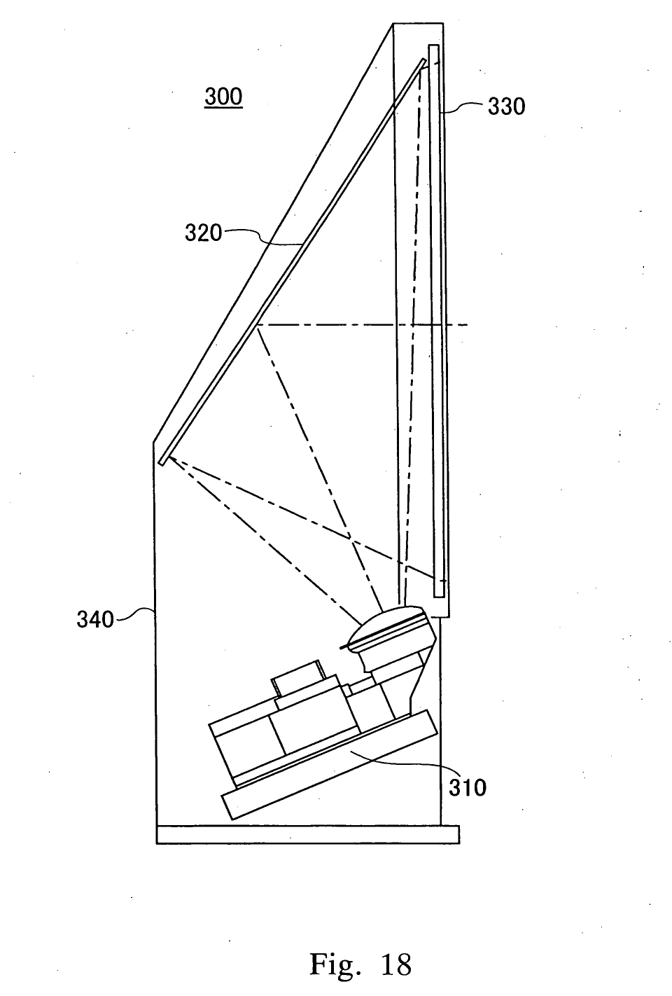

FIG. 18 is a diagram schematically showing a structure of the rear projection according to the present invention.

As shown in FIG. 18, a rear projection 300 has a structure in which a projection optical unit 310, a light guiding mirror 320 and a transmission screen 330 are arranged in a casing 340.

Since the rear projection 300 uses the transmission screen 200 which hardly generates diffracted light or moire as described above as its transmission screen 330, it forms an excellent rear projection with a high display quality, which has a wide view angle and free from occurrence of moire.

As described above, in the substrate with concave portions (the substrate with concave portions for microlenses) and the microlens substrate of the present invention, since the concave portions (the concave portions for microlenses) and the microlenses are arranged randomly (i.e., in an optically random order), it is possible to prevent optical interference.

Thus, in the transmission screen or the rear projection using the microlens substrate of the present invention, it is possible to prevent light valve of a liquid crystal display (LCD) or the like, or interference to the Fresnel lens, for example. This makes it possible to prevent occurrence of moire almost completely. Thus, it is possible to obtain an excellent transmission screen with a high display quality.

As described above, it should be noted that, even though the substrate with concave portions, the microlens substrate, the transmission screen and the rear projection according to the present invention have been described with reference to the preferred embodiments shown in the accompanying drawings, the present invention is not limited to these embodiments.

For example, the substrate with concave portions of the present invention is not limited to a substrate with concave portions manufactured by the method described above. Namely, the substrate with concave portions of the present invention may be a substrate with concave portions manufactured by the photolithography method, which does not include the initial hole formation process by means of the physical method or the irradiation with laser beams, or the like, for example.

Further, in the initial hole formation process in the above description, the structure in which shot blast is carried out while moving the nozzle 610 one-dimensionally (in a linear manner) has been described. However, the blast processing may be carried out while moving the nozzle 610 two-dimensionally (in a planar manner) or three-dimensionally (in a spatial manner).

Moreover, the transmission screen and the rear projection according to the invention are not limited to the types as described in the embodiments, and each element constituting the transmission screen and the rear projection may be replaced with one capable of performing the same or a similar function. For example, the transmission screen of the invention may be a transmission screen further including black stripes, a light diffusion plate or any other microlens substrate on the emission face side of the microlens substrate 1.

Further, in the above description, the cases of applying the microlens substrate of the invention to the transmission screen and the projection display provided with the transmission screen have been described as the examples, but the present invention is not limited to these cases. For example, needless to say, the microlens substrate of the invention may be applied to a CCD, various kinds of electro-optical devices such as an optical communication device, a liquid crystal display (liquid crystal panel), an organic or inorganic electroluminescent (EL) display and other devices.

In addition, the display is also not limited to the rear projection type display, and the microlens substrate of the invention can be applied, for example, to a front projection type display.

Furthermore, in the above description, the case of applying the substrate with concave portions of the invention to the substrate with concave portions for microlenses has been described as an example, the present invention is not limited to this case, and the substrate with concave portions of the invention can be applied, for example, to a reflector (reflection plate) in various kinds of light emission sources such as an organic EL device, a reflector for reflecting light from a light source, a light diffusion plate for diffusing light from a light emission source, or the like.

### EXAMPLE

### Example 1

A substrate with concave portions for microlenses equipped with concave portions for microlenses was manufactured, and then a microlens substrate was manufactured using the substrate with concave portions for microlenses in the following manner.

First, a soda-lime glass substrate having a rectangle of 1.2 m×0.7 m and a thickness of 0.7 mm was prepared.

The substrate of soda-lime glass was soaked in cleaning liquid (i.e., 10 vol % (i.e., 10 volume percent) aqueous solution of hydrogen fluoride (containing a small amount of glycerin)) heated to 30° C. to be washed, thereby cleaning its surface.

—1A—Next, chromium oxide films (a mask and a rear face protective film) each having a thickness of 0.21 μm were formed on the soda-lime glass substrate by means of a sputtering method.

—2A—Next, shot blast was carried out to the mask to form a large number of initial holes within a region of 113 cm×65 cm at the central part of the mask.

Here, the shot blast was carried out under the conditions of a blast pressure of 5 kg/cm² and a spraying density of 100 kg/m² using glass beads of average grain diameter of 100 μm as blast media.

In this way, the initial holes were formed in a random pattern over the entire region of the mask mentioned above. The average diameter of the initial holes was 10 μm, and the formation density of the initial holes was 20,000 holes/cm².

In addition, at this time, initial concave portions each having a depth of about 0.1 μm were formed on the surface of the soda-lime glass substrate.

—3A—Next, the soda-lime glass substrate was subjected to a wet etching process, thereby forming a large number of concave portions on the soda-lime glass substrate.

In this regard, 40 wt % aqueous solution of ammonium hydrogen difluoride was used for the wet etching as an etchant, and the soak time of the substrate was 100 hours.

—4—Next, the chromium oxide films (mask and rear face protective film) were removed by carrying out an etching process using a mixture of ceric ammonium nitrate and perchloric acid.

As a result, a wafer-like substrate with concave portions for microlenses where a large number of concave portions for microlenses were randomly formed on the soda-lime glass substrate was obtained. A ratio of an area occupied by all the concave portions in a usable area where the concave portions are formed to the entire usable area is 96% when viewed from a top of the obtained substrate with concave portions. A large number of distances between arbitrarily adjacent two points (i.e., between a concave portion and an adjacent concave portion) were obtained, and then a standard deviation of these distances was calculated. The standard deviation obtained by such a calculation was 20% of the average value of the large number of distances.

—5A—Next, by using the substrate with concave portions for microlenses as a mold, polymethyl methacrylate (PMMA, which has a refractive index of 1.49) resin was formed (or processed) by means of a casting mold (i.e., molding by polymerization method).

In this way, a microlens substrate with an area of 1.2 m×0.7 m on which a large number of microlenses were randomly formed was obtained. The average diameter of the formed microlenses was 100 μm. Further, a large number of distances between arbitrarily adjacent two points (i.e., between a microlens and an adjacent microlens) were obtained, and then a standard deviation of these distances was calculated. The standard deviation obtained by such a calculation was 20% of the average value of the large number of distances.

### Example 2

First, a soda-lime glass substrate having a rectangle of 1.2 m×0.7 m and a thickness of 0.7 mm was prepared.

The substrate of soda-lime glass was soaked in cleaning liquid (i.e., 10 vol % (i.e., 10 volume percent) aqueous solution of hydrogen fluoride (containing a small amount of glycerin)) heated to 30° C. to be washed, thereby cleaning its surface.

—1B—Next, chromium oxide films (a mask and a rear face protective film) each having a thickness of 0.15 μm were formed on the soda-lime glass substrate by means of a sputtering method.

—2B—Next, laser machining was carried out to the mask to form a large number of initial holes within a region of 113 cm×65 cm at the central part of the mask.

In this regard, the laser machining was carried out using a YAG laser under the conditions of energy intensity of 1 W, a beam diameter of 5 μm, and an irradiation time of 0.01 sec.

In this way, the initial holes were formed in a random pattern over the entire region of the mask mentioned above. The average diameter of the initial holes was 7 μm, and the formation density of the initial holes was 40,000 holes/cm².

In addition, at this time, initial concave portions each having a depth of about 0.1 μm were formed on the surface of the soda-lime glass substrate.

—3B—Next, the soda-lime glass substrate was subjected to a wet etching process, thereby forming a large number of concave portions on the soda-lime glass substrate.

In this regard, 40 wt % aqueous solution of ammonium hydrogen difluoride was used for the wet etching as an etchant, and the soak time of the substrate was 100 hours.

—4B—Next, the chromium oxide films (mask and rear face protective film) were removed by carrying out an etching process using a mixture of ceric ammonium nitrate and perchloric acid.

As a result, a wafer-like substrate with concave portions for microlenses where a large number of concave portions for microlenses were randomly formed on the soda-lime glass substrate was obtained. A ratio of an area occupied by all the concave portions in a usable area where the concave portions are formed to the entire usable area is 97% when viewed from a top of the obtained substrate with concave portions. A large number of distances between arbitrarily adjacent two points (i.e., between a concave portion and an adjacent concave portion) were obtained, and then a standard deviation of these distances was calculated. The standard deviation obtained by such a calculation was 35% of the average value of the large number of distances.

Then, similar to the Example 1, by carrying out the —5A— step mentioned above, a microlens substrate with an area of 1.2 m×0.7 m on which a large number of microlenses were randomly formed was obtained. The average diameter of the formed microlenses was 80 μm. Further, a large number of distances between arbitrarily adjacent two points (i.e., between a microlens and an adjacent microlens) were obtained, and then a standard deviation of these distances was calculated. The standard deviation obtained by such a calculation was 35% of the average value of the large number of distances.

### Example 3

First, a soda-lime glass substrate having a rectangle of 1.2 m×0.7 m and a thickness of 0.7 mm was prepared.

The substrate of soda-lime glass was soaked in cleaning liquid (i.e., a mixture of 80 vol % aqueous solution of concentrated sulfuric acid and 20 vol % aqueous solution of 30 vol % hydrogen peroxide solution) heated to 100° C. to be washed, thereby cleaning its surface.

—2C— Next, shot blast was carried out to the soda-lime glass substrate to form a large number of initial concave portions within a region of 113 cm×65 cm at the central part thereof.

Here, the shot blast was carried out under the conditions of a blast pressure of 3 kg/cm² and a spraying density of 30 kg/m² using glass beads of average grain diameter of 20 μm as blast media.

In this way, the initial concave portions were formed in a random pattern over the entire region of the soda-lime glass substrate mentioned above. The average diameter of the initial concave portions was 30 μm, and the formation density of the initial concave portions was 4,000 portions/cm². In addition, at this time, an average interval between adjacent initial concave portions was 150 μm.

—3C— Next, the soda-lime glass substrate was subjected to a wet etching process, thereby forming a large number of concave portions on the soda-lime glass substrate.

In this regard, 40 wt % aqueous solution of ammonium hydrogen difluoride was used for the wet etching as an etchant, and the soak time of the substrate was 160 hours.

—4C— Next, shot blast was carried out to the face of the soda-lime glass substrate on which the concave portions have been formed at the step described above to newly form a large number of initial concave portions within a region of 113 cm×65 cm at the central part thereof.

Here, the shot blast was carried out under the conditions of a blast pressure of 5 kg/cm² and a spraying density of 100 kg/m² using glass beads of average grain diameter of 50 μm as blast media.

In this way, the initial concave portions were newly formed in a random pattern over the entire region of the soda-lime glass substrate mentioned above. The average diameter of the initial concave portions was 80 μm, and the formation density of the initial concave portions was 20,000 portions/cm². In addition, at this time, an average interval between adjacent initial concave portions was 100 μm.

—5C— Next, the face of the soda-lime glass substrate on which the initial concave portions have been formed was subjected to a wet etching process, thereby forming a large number of concave portions on the soda-lime glass substrate.

In this regard, 40 wt % aqueous solution of ammonium hydrogen difluoride was used for the wet etching as an etchant, and the soak time of the substrate was 100 hours.

As a result, a wafer-like substrate with concave portions for microlenses where a large number of concave portions for microlenses were randomly formed on the soda-lime glass substrate was obtained. In this case, a curvature radius of the formed concave portion (i.e., a curvature radius near the central portion of the microlens) was 50 μm, and an interval between two adjacent concave portions (average distance between the centers of two adjacent concave portions) was 80 μm. Further, a ratio of an area occupied by all the concave portions in a usable area where the concave portions are formed to the entire usable area is 100% when viewed from a top of the obtained substrate with concave portions. A large number of distances between arbitrarily adjacent two points (i.e., between a concave portion and an adjacent concave portion) were obtained, and then a standard deviation of these distances was calculated. The standard deviation obtained by such a calculation was 3% of the average value of the large number of distances.

—6C— Next, a non-polymerized resin (i.e., a UV-cure optical epoxy adhesive (which has a refractive index of 1.59 after cured)) was applied to the face on which the concave portions of the substrate with concave portions for microlenses were formed. Then, this resin was polymerized and hardened by carrying out irradiation with ultraviolet rays, thereby forming the resin having a large number of microlenses.

—7C— Next, the substrate with concave portions for microlenses that was a mold for the microlenses was removed from the microlenses (i.e., the resin layer), whereby, a microlens substrate having a rectangle of 1.2 m×0.7 m on which the large number of microlenses 8 were randomly arranged was obtained. The average diameter of the formed microlenses was 100 μm. Further, a large number of distances between arbitrarily adjacent two points (i.e., between a microlens and an adjacent microlens) were obtained, and then a standard deviation of these distances was calculated. The standard deviation obtained by such a calculation was 3% of the average value of the large number of distances.

First, a quartz glass substrate having a rectangle of 1.2 m×0.7 m and a thickness of 2.0 mm was prepared.

The quartz glass substrate was soaked in cleaning liquid (i.e., 10 vol % (i.e., 10 volume percent) aqueous solution of hydrogen fluoride (containing a small amount of glycerin)) heated to 30° C. to be washed, thereby cleaning its surface.

—2D— Next, a large number of initial concave portions were formed within a region of 113 cm×65 cm at the central part thereof on the quartz glass substrate using a femtosecond laser.

In this regard, the irradiation with the femtosecond laser was carried out under the conditions of energy intensity of 0.1 W, a beam diameter of 5 μm, and an irradiation time of 0.1 sec.

In this way, the initial concave portions were formed in a random pattern over the entire region of the quartz glass substrate mentioned above. The average diameter of the formed initial concave portions was 10 μm, the depth of each of the initial concave portions was 50 μm, and the average interval between two adjacent initial concave portions was 50 μm.

—3D— Next, the face of the quartz glass substrate on which the initial concave portions have been formed was subjected to a wet etching process, thereby forming a large number of concave portions on the quartz glass substrate.

In this regard, a mixture of 10 wt % hydrogen fluoride solution and 15 wt % glycerin solution was used for the wet etching as an etchant at room temperature, and the soak time of the substrate was 6.5 hours.

—4D— Next, a large number of initial concave portions were newly formed within a region of 113 cm×65 cm at the central part thereof on the face of the quartz glass substrate on which the concave portions have been formed at the step described above using a femtosecond laser.

In this regard, the irradiation with the femtosecond laser was carried out under the conditions of energy intensity of 0.1 W, a beam diameter of 5 μm, and an irradiation time of 0.02 sec.

In this way, the initial concave portions were newly formed in a random pattern over the entire region of the quartz glass substrate mentioned above. The average diameter of the formed initial concave portions was 10 μm, the depth of each of the initial concave portions was 10 μm, and the average interval between two adjacent initial concave portions was 50 μm.

—5D— Next, the quartz glass substrate was subjected to a wet etching process, thereby newly forming a large number of concave portions on the quartz glass substrate.

In this regard, a mixture of 10 wt % hydrogen fluoride solution and 15 wt % glycerin solution was used for the wet etching as an etchant at room temperature, and the soak time of the substrate was 80 minutes.

In this regard, 40 wt % aqueous solution of ammonium hydrogen difluoride was used for the wet etching as an etchant, and the soak time of the substrate was 100 hours.

As a result, a wafer-like substrate with concave portions for microlenses where a large number of concave portions for microlenses were randomly formed on the quartz glass substrate was obtained. In this case, a curvature radius of the formed concave portion (i.e., a curvature radius near the central portion of the microlens) was 20 μm, and an interval between two adjacent concave portions (average distance between the centers of two adjacent concave portions) was 30 μm. Further, a ratio of an area occupied by all the concave portions in a usable area where the concave portions are formed to the entire usable area is 100% when viewed from a top of the obtained substrate with concave portions. A large number of distances between arbitrarily adjacent two points (i.e., between a concave portion and an adjacent concave portion) were obtained, and then a standard deviation of these distances was calculated. The standard deviation obtained by such a calculation was 10% of the average value of the large number of distances.

—6D— Next, a non-polymerized resin (i.e., a UV-cure optical epoxy adhesive (which has a refractive index of 1.59 after cured)) was applied to the face on which the concave portions of the substrate with concave portions for microlenses were formed. Then, this resin was polymerized and hardened by carrying out irradiation with ultraviolet rays, thereby forming the resin having a large number of microlenses.

—7D— Next, the substrate with concave portions for microlenses that was a mold for the microlenses was removed from the microlenses (i.e., the resin layer), whereby, a microlens substrate having a rectangle of 1.2 m×0.7 m on which the large number of microlenses 8 were randomly arranged was obtained. The average diameter of the formed microlenses was 40 μm. Further, a large number of distances between arbitrarily adjacent two points (i.e., between a microlens and an adjacent microlens) were obtained, and then a standard deviation of these distances was calculated. The standard deviation obtained by such a calculation was 10% of the average value of the large number of distances.

### Comparative Example

First, a quartz glass substrate with thickness of 1 mm was prepared.

The quartz glass substrate was soaked in a cleaning liquid (i.e., a mixture of 80% sulfuric acid solution and 20% hydrogen peroxide solution) heated to 85° C. to be washed, thereby cleaning its surface.

—1E— Next, the quartz glass substrate was placed in a CVD furnace set at 600° C. and 80 Pa, SiH₄ gas was supplied into the CVD furnace at a rate of 300 mL/minute, whereby polycrystalline silicon films (a mask and a rear face protective film) with thickness of 0.6 μm was formed by means of a CVD method.

—2E— Next, a resist having a regular pattern of microlenses was formed on the formed polycrystalline silicon film (mask) by means of a photolithography method, and then, a dry etching process was carried out to the polycrystalline silicon film (mask) to using CF gas. Then, openings were formed in the polycrystalline silicon film (mask) by removing the resist.

—3E— Next, a large number of concave portions were formed on the quartz glass substrate by subjecting the quartz glass substrate to a first wet etching process.

In this process, a hydrofluoric-based etching liquid was used as an etchant.

—4E— Next, the polycrystalline silicon films (the mask and the rear face protective film) were removed by means of a dry etching process using CF gas.

In this way, a wafer-like substrate with concave portions for microlenses in which a large number of concave portions for microlenses were regularly formed on the quartz glass substrate was obtained. Further, a ratio of an area occupied by all the concave portions in a usable area where the concave portions are formed to the entire usable area is 98% when viewed from a top of the obtained substrate with concave portions.

Then, the —5A— process mentioned above was carried out, and a microlens substrate on which a large number of microlenses were regularly formed was obtained similar to Example 1. The average diameter of the formed microlenses was 72 μm.

### Evaluation

In Examples 1 and 2 in which openings (initial holes) were formed by means of a physical method or irradiation with laser beams, a processing for a large-sized substrate such as 1.2 m×0.7 m could be implemented easily. Further, in Examples 3 and 4 in which initial concave portions of a base material were directly formed without forming a mask, a processing for a large-sized substrate such as 1.2 m×0.7 m could be also implemented easily. On the other hand, in the comparative example in which the openings were formed in the mask by a photolithography method, it was difficult to implement a processing for a large-sized substrate such as 1.2 m×0.7 m. In particular, since numerous defective products were generated in the photoresist process, the yield was inferior.

Using the microlens substrate obtained by Examples 1 to 4 and Comparative Example described above, transmission screens as shown in FIGS. 16 and 17 were manufactured, and the rear projections as shown in FIG. 18 were respectively manufactured using the transmission screens.

When an image was projected onto each screen of the rear projections obtained, a bright image could be displayed. Further, it was confirmed that occurrence of diffracted light or moire was satisfactorily prevented in the rear projections using the microlens substrate according to Examples 1 to 4. On the other hand, it was confirmed that diffracted light and moire occurred in the rear projection using the microlens substrate according to Comparative Example.

Accordingly, it is readily conjectured that a projection display using such a transmission screen is capable of projecting a bright image of high quality on the screen.

1. A substrate comprising a plurality of concave portions being formed on the substrate by means of an etching process so that the plurality of concave portions are randomly arranged on the substrate.

2. The substrate as claimed in claim 1, wherein the substrate is constituted from soda-lime glass..

3. The substrate as claimed in claim 1, wherein the substrate has a usable area in which all the concave portions are formed wherein a ratio of an area occupied by all the concave portions in the usable area to the entire usable area is 90% or more when viewed from a top of the substrate.

4. The substrate as claimed in claim 1, wherein the concave portions are used for manufacturing microlenses.

5. A microlens substrate comprising a plurality of microlenses arranged on the substrate in an optically random order, the microlens substrate being manufactured using a substrate with a plurality of concave portions for providing the microlenses, the plurality of concave portions being formed on the substrate by means of an etching process so that the plurality of concave portions are randomly arranged on the substrate.

6. A transmission screen comprising a microlens substrate with a plurality of microlenses arranged on the substrate in an optically random order, the microlens substrate being manufactured using a substrate with a plurality of concave portions for providing the microlenses, the plurality of concave portions being formed on the substrate by means of an etching process so that the plurality of concave portions are randomly arranged on the substrate.

7. The transmission screen as claimed in claim 6, further comprising a Fresnel lens portion with a Fresnel lens, the Fresnel lens portion having an emission face and the Fresnel lens being formed in the emission face wherein the microlens substrate is arranged on the emission face side of the Fresnel lens portion.

8. The transmission screen as claimed in claim 6, wherein the diameter of each of the microlenses is in the range of 10 to 500 μm.

9. A rear projection comprising a transmission screen, the transmission screen having a microlens substrate with a plurality of microlenses arranged on the substrate in an optically random order, the microlens substrate being manufactured using a substrate with a plurality of concave portions for providing the microlenses, the plurality of concave portions being formed on the substrate by means of an etching process so that the plurality of concave portions are randomly arranged on the substrate.

10. The rear projection as claimed in claim 9, further comprising:
a projection optical unit; and
a light guiding mirror.
